(19) United States
(12) Patent Application Publication
(10) Pub. No.: US 2011/0285611 A1
(43) Pub. Date: Nov. 24, 2011

(54) LIQUID CRYSTAL DISPLAY

(75) Inventors: Mitsuyasu ASANO, Tokyo (JP); Toshinori Ihara, Tokyo (JP); Tomohiro Nishi, Tokyo (JP)

(73) Assignee: Sony Corporation, Tokyo (JP)

(21) Appl. No.: 13/082,809

(22) Filed: Apr. 8, 2011

(30) Foreign Application Priority Data
May 18, 2010 (JP) 2010-114655

(51) Int. Cl. G09G 3/36

(52) U.S. Cl. 345/87

(57) ABSTRACT

A liquid crystal display includes: a light source section including emission subsections; a liquid crystal display panel performing image display through modulating light coming from each of the emission subsections; and a display control section having a partitioning-drive processing section which generates an emission-pattern signal and a partitioning-drive image signal and performs light-emission drive on each of the emission subsections, and performing display-drive on the liquid crystal display panel. The partitioning-drive processing section calculates a first maximum pixel value and a first average pixel value the first maximum pixel value representing a maximum pixel value in each of pixel regions which correspond to the respective emission subsections, and the first average pixel value representing an average pixel value in each of the pixel regions, and generates the emission-pattern signal and the partitioning-drive image signal based on both the first maximum pixel value and the first average pixel value.

### BACKGROUND OF THE INVENTION

1. Field of the Invention

The present invention relates to a liquid crystal display provided with a light source section having a plurality of emission subsections.

2. Description of Related Art

As a display of a slim television or a mobile terminal device, an active-matrix type liquid crystal display (LCD) provided with a thin film transistor (TFT) for a pixel has been widely used in recent years. In such a liquid crystal display, pixels are generally driven from the upper to lower of the screen by an image signal written into an auxiliary capacity element and a liquid crystal element of the pixels line-sequentially.

A light source using a cold cathode fluorescent lamp (CCFL) is mainly used for a backlight of the liquid crystal display, however, a light source using light emitting diode (LED) is recently showing up.

In the proposed liquid crystal display using LED or the like as a backlight, a light source section includes a plurality of emission subsections, and the emission subsections are controlled to perform emission operation separately from one another (for example, see Japanese Unexamined Patent Application Publication No. 2001-142409). During such a partitioning-emission operation, an emission-pattern signal and a partitioning-drive image signal are generated based on an input image signal. The emission-pattern signal represents an emission pattern in each of the emission subsections in the backlight.

### SUMMARY OF THE INVENTION

At the time of displaying image with use of such a partitioning-emission operation, for example, as described in Japanese Unexamined Patent Application Publication No. 2003-99010, an emission-pattern signal is typically generated based on a maximum pixel value (peak value) in each of the pixel regions corresponding to the respective emission subsections of the input image signal. In other words, according to the magnitude of the maximum pixel value in each of the pixel regions corresponding to the respective emission subsections, the emission luminance is determined for each of the emission subsections.

However, in this technique, there is difficulty in reducing power consumption because the emission luminance of the emission subsection is set higher than it needs depending on the content of the input image signal (pattern of the input image). In other words, for example, at the time of displaying an image or the like in which a small object with high luminance is present in a background with low luminance, even if the small object is of one pixel, the emission luminance of the emission subsection is determined based on the maximum pixel value corresponding to the luminance of the small object. Therefore, in such a case, the emission luminance is set higher than it needs, thereby increasing the power consumption. In this case, in contrast, if the emission luminance of the emission subsection is decreased lower than it needs, the power consumption may be reduced but the display quality (display luminance) may be decreased.

As described above, proposition of a technique is desirable for achieving low power consumption without degrading the display image quality (with almost maintaining the display image quality) at the time of displaying an image with use of a light source which performs partitioning-emission operation.

It is desirable to provide an liquid crystal display capable of reducing power consumption with almost maintaining the display quality during image display using a light source section which performs a partitioning-emission operation.

A liquid crystal display according to an embodiment of the invention includes: a light source section including a plurality of emission subsections which are controlled separately from one another; a liquid crystal display panel performing image display through modulating, based on an input image signal, light coming from each of the emission subsections in the light source section; and a display control section having a partitioning-drive processing section which generates an emission-pattern signal and a partitioning-drive image signal based on the input image signal, the emission-pattern signal representing an emission-pattern formed of lighting emission subsections in the light source section, the display control section performing light-emission drive on each of the emission subsections in the light source section with use of the emission-pattern signal, and performing display-drive on the liquid crystal display panel with use of the partitioning-drive image signal. The partitioning-drive processing section performs, calculation of a first maximum pixel value and a first average pixel value based on the input image signal, the first maximum pixel value representing a maximum pixel value in each of pixel regions which correspond to the respective emission subsections, and the first average pixel value representing an average pixel value in each of the pixel regions, and generation of the emission-pattern signal and the partitioning-drive image signal based on both the first maximum pixel value and the first average pixel value.

In the liquid crystal display according to an embodiment of the invention, the emission-pattern signal and the partitioning-drive image signal are generated based on the input image signal, the emission-pattern signal representing the emission pattern in each of the emission subsections of the light source section. Then, the light-emission drive is performed for each of the emission subsections of the light source section with use of the emission-pattern signal, and the display-drive is performed for the liquid crystal display panel with use of the partitioning-drive image signal. At this time, the first maximum pixel value and the first average pixel value are calculated based on the input image signal, the first maximum pixel value being a maximum pixel value in each of the pixel regions corresponding to each of the emission subsections, and the first average pixel value being an average pixel value in each of the pixel regions corresponding to each of the emission subsections. Then, based on both the first maximum pixel value and the first average pixel value, the emission-pattern signal and the partitioning-drive image signal are generated. Therefore, for example, at the time of displaying an image or the like in which a small object with high luminance is present in a background with low luminance, emission luminance is suppressed in the emission subsections, compared with the case where the emission-pattern signal and the partitioning-drive image signal are generated with use of only the maximum pixel value (the first maximum pixel value) in each of the pixel regions corresponding to each of the emission subsections. Moreover, in this way, feeling of discomfort associated with the display quality is almost eliminated.

According to the liquid crystal display of an embodiment of the invention, the first maximum pixel value, which is a maximum pixel value in each of the pixel regions corresponding to the respective emission subsections, and the first average pixel value, which is an average pixel value in each of the pixel regions corresponding to the respective emission subsections, are calculated based on the input image signal, and the emission-pattern signal and the partitioning-drive image signal are generated based on both the first maximum pixel value and the first average pixel value. Therefore, the emission luminance in the emission subsections may be suppressed while feeling of discomfort associated with the display quality is almost eliminated. Accordingly, at the time of displaying image using the light source section which performs the partitioning-emission operation, the power consumption may be reduced while almost maintaining the display quality.

Other and further objects, features and advantages of the invention will appear more fully from the following description.

### BRIEF DESCRIPTION OF THE DRAWINGS

FIG. 1 is a block diagram illustrating a whole configuration of a liquid crystal display according to an embodiment of the invention.

FIG. 2 is a circuit diagram illustrating a detailed configuration example of a pixel illustrated in FIG. 1.

FIG. 3 is an exploded perspective view schematically illustrating examples of emission sub-regions and irradiation sub-regions in the liquid crystal display illustrated in FIG. 1.

FIG. 4 is a block diagram illustrating a detailed configuration of a partitioning-drive processing section illustrated in FIG. 1.

FIG. 5 is a schematic diagram illustrating an outline of a partitioning-emission operation of a backlight in the liquid crystal display illustrated in FIG. 1.

FIG. 6 is a schematic waveform chart illustrating the outline of the partitioning-emission operation of the backlight in the liquid crystal display illustrated in FIG. 1.

FIG. 7 is a block diagram illustrating a configuration of a partitioning-drive processing section in a liquid crystal display according to a comparative example.

FIG. 8 is a schematic diagram illustrating an example of an input image.

FIGS. 9A and 9B are waveform charts for describing a generation operation of an emission-pattern signal according to the comparative example.

FIGS. 10A to 10C are waveform charts for describing a generation operation of an emission-pattern signal according to the embodiment.

FIG. 11 is a block diagram illustrating a configuration of a partitioning-drive processing section according to a modification 1 of the embodiment.

FIG. 12 is a schematic diagram for describing an operation of a combining ratio calculation section illustrated in FIG. 11.

FIG. 13 is a schematic diagram illustrating another example of a relationship between a display average value and a combining ratio illustrated in FIG. 12.

FIGS. 14A and 14B are schematic diagrams illustrating another example of the input image.

FIG. 15 is a block diagram illustrating a configuration of a partitioning-drive processing section according to a modification 2 of the embodiment.

FIG. 16 is a schematic diagram for describing an operation of a combining ratio calculation section illustrated in FIG. 15.

FIGS. 17A and 17B are schematic diagrams illustrating still another example of the input image.

FIGS. 18A to 18C are schematic diagrams illustrating a partitioning-emission operation of a backlight according to another modification of the embodiment.

### DETAILED DESCRIPTION OF THE PREFERRED EMBODIMENTS

Hereinafter, preferred embodiments of the invention will be described in detail with reference to drawings. The description will be given in the following order.

1. Embodiment (example of generating an emission-pattern signal with use of a combined value of an average value and a maximum value in each of emission sub-regions)

### 2. Modifications

Modification 1 (example of determining a combining ratio with use of a screen average value)

Modification 2 (example of determining a combining ratio with use of a difference value between a screen maximum value and a screen average value)

Other modifications (examples of an edge-type backlight and the like)

### Embodiment

Whole Configuration of Liquid Crystal Display 1

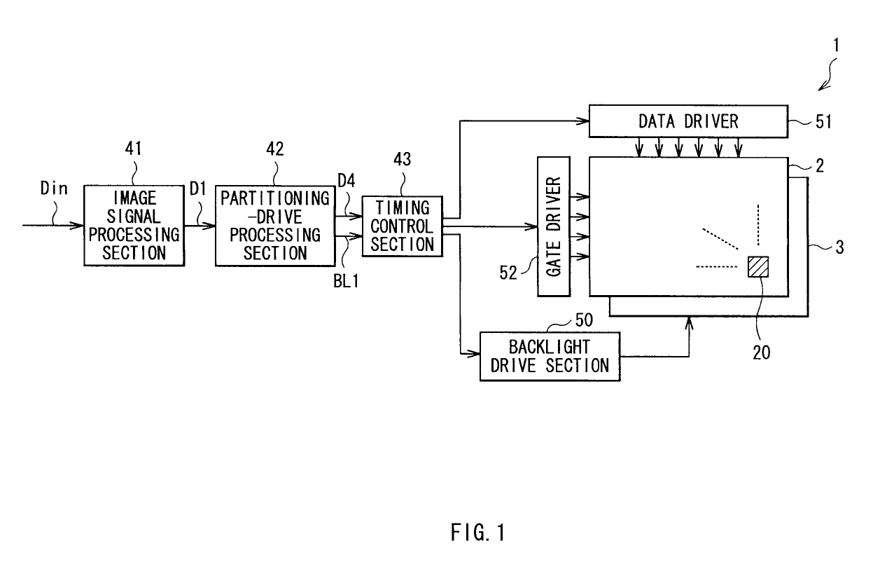

FIG. 1 is a block diagram illustrating a whole configuration of a liquid crystal display (a liquid crystal display 1) according to an embodiment of the invention.

The liquid crystal display 1 performs image display based on an input image signal Din input externally. The liquid crystal display 1 includes a liquid crystal display panel 2, a backlight 3 (a light source section), an image signal processing section 41, a partitioning-drive processing section 42, a timing control section 43, a backlight drive section 50, a data driver 51 and a gate driver 52. Of these, the image signal processing section 41, the partitioning-drive processing section 42, the timing control section 43, the backlight drive section 50, the data driver 51 and the gate driver 52 correspond to a specific example of a “display control section” of the invention.

The liquid crystal display panel 2 modulates light emitted from the backlight 3, which will be described later, based on the input image signal Din to perform image display based on the input image signal Din. The liquid crystal display panel 2 includes a plurality of pixels 20 arranged in a matrix as a whole.

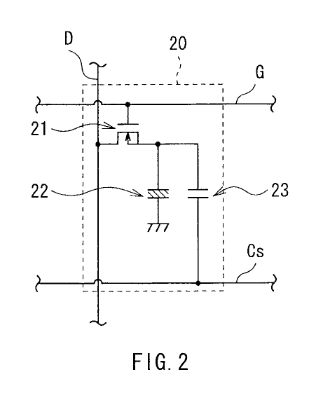

FIG. 2 illustrates an example of a circuit configuration of a pixel circuit in each pixel 20. The pixel 20 includes a liquid crystal element 22, a TFT element 21 and an auxiliary capacity element 23. The pixel 20 is connected with a gate line G, a data line D and an auxiliary capacity line Cs. The gate line G is for line-sequentially selecting pixels to be driven, and the data line D is for supplying an image voltage (an image voltage supplied from the data driver 51 which will be described later) to pixels to be driven.

The liquid crystal element 22 performs display operation depending on the image voltage supplied from the data line D to an end of the liquid crystal element 22 through the TFT element 21. The liquid crystal element 22 is configured by sandwiching a liquid crystal layer (not shown) made of a liquid crystal of a vertical alignment (VA) mode or a twisted nematic (TN) mode by a pair of electrodes (not shown). One (end) of the pair of electrodes in the liquid crystal element 22 is connected to a drain of the TFT element 21 and one end of the auxiliary capacity element 23, and the other (end) is grounded. The auxiliary capacity element 23 is a capacity element for stabilizing an accumulated charge in the liquid crystal element 22. One end of the auxiliary capacity element 23 is connected to one end of the liquid crystal element 22 and the drain of the TFT element 21, and the other end is connected to the auxiliary capacity line Cs. The TFT element 21 is a switching element for supplying an image voltage based on an image signal D1 to one end of the liquid crystal element 22 and one end of the auxiliary capacity element 23, and is configured of a metal oxide semiconductor-field effect transistor (MOS-FET). A gate of the TFT element 21 is connected to the gate line G, a source thereof is connected to the data line D, and the drain is connected to one end of the liquid crystal element 22 and one end of the auxiliary capacity element 23.

The backlight 3 is a light source section irradiating the liquid crystal display panel 2 with light, and configured by using a CCFL or LED as a light emission element. As will be described later, the backlight 3 is driven to emit light depending on a content of the input image signal Din (an image pattern).

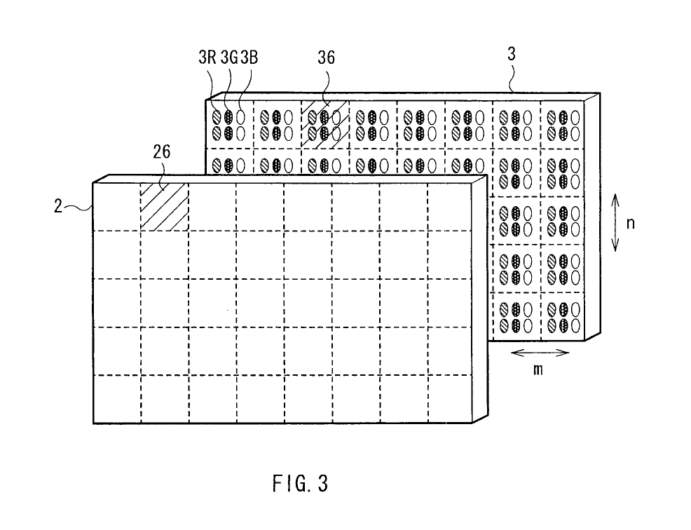

The backlight 3 also has a plurality of emission sub-regions 36 (emission subsections) configured to be controlled independently, for example, as illustrated in FIG. 3. In other words, the backlight 3 is configured of partitioning-drive backlights. Specifically, the backlight 3 has the plurality of emission sub-regions 36 having a plurality of light sources two-dimensionally arranged. Accordingly, the emission region of the backlight 3 is partitioned into n vertical*m horizontal=K (n and m are an integer of 2 or more). Note that the number of partition is set such that the resolution is lower than that of the pixels 20 in the liquid crystal display panel 2 described above. In addition, as illustrated in FIG. 3, a plurality of irradiation sub-regions 26 corresponding to the emission sub-regions 36 are formed in the liquid crystal display panel 2.

In the backlight 3, the emission sub-regions 36 may be controlled to perform light emission separately from one another depending on a content of the input image signal Din (an image pattern). The light source of the backlight 3 is configured by combining a red LED 3R emitting red light, a green LED 3G emitting green light, and a blue LED 3B emitting blue light. However, the kind of the LED used for the light source is not limited thereto, and for example, a white LED emitting white light may be used. In each of the emission sub-regions 36, one or more light sources are provided.

The image signal processing section 41 generates the image signal D1 by performing, for example, a predetermined image processing for improving image quality on the input image signal Din including a pixel signals of each of the pixels 20. Examples of the predetermined image processing include a sharpness processing and a gamma correction processing.

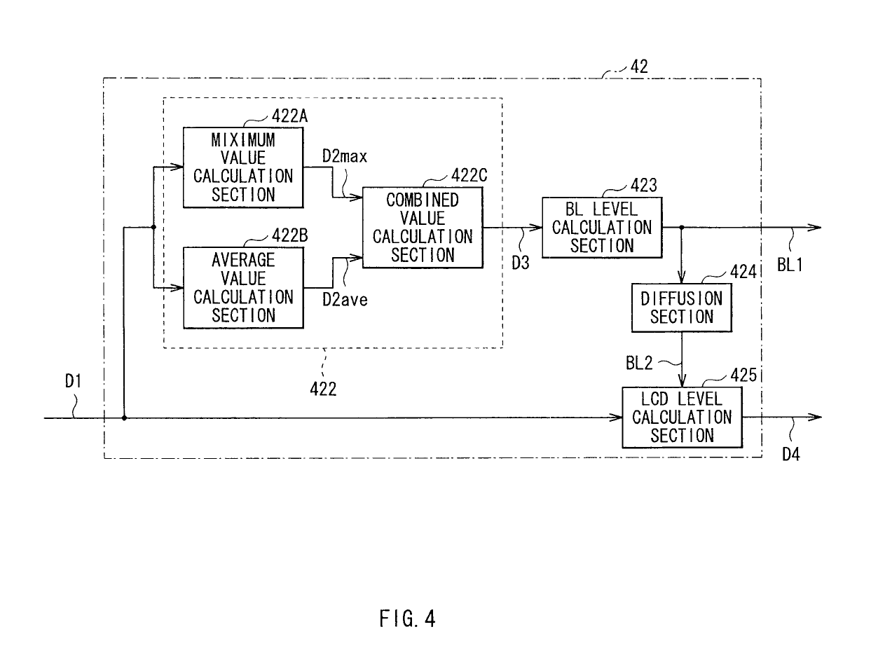

The partitioning-drive processing section 42 performs a predetermined partitioning-drive processing on the image signal D1 supplied from the image signal processing section 41. With this processing, an emission-pattern signal BL1 and a partitioning-drive image signal D4 are generated, the emission pattern signal BL1 representing an emission pattern in each of the emission sub-regions 36 of the backlight 3. Specifically, the partitioning-drive processing section 42 calculates a maximum pixel value (first maximum pixel value) of the emission sub-region 36 and an average pixel value (first average pixel value) per emission sub-region 36 based on the image signal D1. Then, based on both the maximum pixel value and the average pixel value, the partitioning-drive processing section 42 generates the emission-pattern signal BL1 and the partitioning-drive image signal D4. Note that the detailed configuration of the partitioning-drive processing section 42 will be described later (referring to FIG. 4).

The timing control section 43 controls the driving timings of the backlight drive section 50, the gate driver 52 and the data driver 51, and supplies the partitioning-drive image signal D4 from the partitioning-drive processing section 42 to the data driver 51.

The gate driver 52 line-sequentially drives, along the gate lines G, the pixels 20 in the liquid crystal display panel 2 according to the timing control by the timing control section 43. On the other hand, the data driver 51 supplies the image voltage based on the partitioning-drive image signal D4 to the pixels 20 in the liquid crystal display panel 2, the partitioning-drive image signal D4 being supplied from the timing control section 43. Specifically, D/A (digital to analog) conversion is performed on the partitioning-drive image signal D4 to generate the image signal (the image voltage described above) as an analog signal, and the image signal is output to the pixels 20. In this way, the pixels 20 in the liquid crystal display panel 2 are driven for display based on the partitioning-drive image signal D4.

The backlight drive section 50 performs emission drive (illumination drive) on the emission sub-regions 36 in the backlight 3 based on the emission-pattern signal BL1 provided from the partitioning-drive processing section 42 and according to the timing control by the timing control section 43.

Detailed Configuration of Partitioning-Drive Processing Section 42

Next, referring to FIG. 4, the configuration of the partitioning-drive processing section 42 is described in detail. FIG. 4 illustrates a block configuration of the partitioning-drive processing section 42. The partitioning-drive processing section 42 includes a resolution reduction processing section 422, a BL level calculation section 423, a diffusion section 424 and an LCD level calculation section 425.

The resolution reduction processing section 422 performs a predetermined resolution reduction processing on the image signal D1 to generate an image signal D3 (a resolution reduction process signal and a block combined value) as a base of the emission-pattern signal BL1 described above. Specifically, the image signal D3 is generated by reconfiguring the image signal D1 which is configured by a luminance level signal (a pixel signal) in each of the pixels 20 to a luminance level signal in each of the emission sub-regions 36 whose resolution is lower than that of the pixel 20. At this time, the resolution reduction processing section 422 performs reconfiguration by extracting a predetermined characteristic amount, which will be described later, from the plurality of pixel signals in the emission sub-regions 36.

The resolution reduction processing section 422 includes a maximum value calculation section 422A, an average value calculation section 422B and a combined value calculation section 422C. The maximum value calculation section 422A calculates, based on the image signal D1, a block maximum pixel value D2max (a first maximum pixel value) that is a maximum pixel value in each of the emission sub-regions 36. The average value calculation section 422B calculates, based on the image signal D1, a block average pixel value D2ave (a first average pixel value) that is an average pixel value in each of the emission sub-regions 36. The combined value calculation section 422C combines the block maximum pixel value D2max from the maximum value calculation section 422A and the block average pixel value D2ave from the average value calculation section 422B at a predetermined combining ratio α, thereby generating the image signal D3 that is a combined value in each of the emission sub-regions 36. To be specific, the combined value calculation section 422C generates (calculates) the image signal D3 with use of the following equation (1). Note that the detailed operation of the resolution reduction processing section 422 will be described later.

D3=α*D2ave+(1−α)*D2max (1)

Based on the image signal D3 output from the resolution reduction processing section 422, the BL level calculation section 423 calculates emission luminance level for the emission sub-region 36 to generate the emission-pattern signal BL1 representing the emission pattern in each of the emission sub-regions 36. Specifically, the BL level calculation section 423 analyzes the luminance level of the image signal D3 for the mission sub-region 36, thereby obtaining the emission pattern depending on the luminance level of the region.

The diffusion section 424 performs a predetermined diffusion processing on the emission-pattern signal BL1 output from the BL level calculation section 423, and then outputs the resultant emission-pattern signal BL2 to the LCD level calculation section 425. In other words, the diffusion section 424 converts the signal in each of the emission sub-regions 36 into the signal in each of the pixels 20. The diffusion processing is performed while taking into consideration the luminance distribution (diffusion distribution of light from the light source) of the actual light source (in this case, LED of each color) in the backlight 3.

The LCD level calculation section 425 generates the partitioning-drive image signal D4 based on the image signal D1 and the emission pattern signal BL2 after the diffusion process. Specifically, the partitioning-drive image signal D4 is generated by dividing the signal level of the image signal D1 by the emission-pattern signal BL2 after the diffusion process. More specifically, the LCD level calculation section 425 generates the image signal D4 with use of the following equation (2).

D4=(D1/BL2) (2)

From the equation (2), the relationship of the original signal (the image signal D1)=(the emission-pattern signal BL2*the partitioning-drive image signal D4) is obtainable. Of these, (the emission-pattern signal BL2*the partitioning-drive image signal D4) physically means that the image of the partitioning-drive image signal D4 is overlaid on the image of the emission sub-region 36 in the backlight 3 that is illuminated with a certain emission pattern. By doing so, although the detail thereof will be described later, the contrast distribution of the light transmitted through the liquid crystal display panel 2 is cancelled, and the display equivalent to the original display (display of the original signal) is observed.

Operation and Effects of Liquid Crystal Display 1

The operation and effects of the liquid crystal display 1 of the embodiment will be described.

1. Outline of Partitioning-Emission Operation

In the liquid crystal display 1, as illustrated in FIG. 1, the image signal processing section 41 performs a predetermined image processing on the input image signal Din to generate the image signal D1. Next, the partitioning-drive processing section 42 performs a predetermined partitioning-drive processing on the image signal D1. In this way, the emission-pattern signal BL1 which represents the emission pattern in each of the emission sub-regions 36 in the backlight 3, and the partitioning-drive image signal D4 are generated.

Subsequently, the partitioning-drive image signal D4 and the emission-pattern signal BL1 thus generated are input to the timing control section 43. Of these, the partitioning-drive image signal D4 is supplied from the timing control section 43 to the data driver 51. The data driver 51 performs D/A conversion on the partitioning-drive image signal D4 to generate the image voltage as an analog signal. Then, the display driving operation is performed by the drive voltage supplied from the gate driver 52 and the data driver 51 to the pixels 20. Therefore, the display driving is performed on the pixels 20 in the liquid crystal display panel 2 based on the partitioning-drive image signal D4.

Specifically, as illustrated in FIG. 2, the TFT element 21 is turned on or off in accordance with a selection signal supplied from the gate driver 52 through the gate line G. In this way, the conduction is selectively made between the data line D, the liquid crystal element 22, and the auxiliary capacity element 23. As a result, the liquid crystal element 22 is supplied with the image voltage based on the partitioning-drive image signal D4 which is provided from the data driver 51 so that the display driving operation is performed line-sequentially.

On the other hand, the emission-pattern signal BL1 is supplied to the backlight drive section 50 from the timing control section 43. The backlight drive section 50 performs, based on the emission-pattern signal BL1, the emission driving (partitioning-drive operation) with respect to the emission sub-regions 36 in the backlight 3.

At this time, in the pixel 20 supplied with the image voltage, illumination light from the backlight 3 is modulated by the liquid crystal display panel 2, and the modulated illumination light is emitted as display light. Consequently, the liquid crystal display 1 displays image based on the input image signal Din.

To be specific, as illustrated in FIG. 5, for example, a composite image 73 is eventually observed at the entire liquid crystal display 1. The composite image 73 is generated by composing in a multiplication manner a panel image 72 represented by the single display panel 2 on the emission image 71 represented by the emission sub-regions 36 in the backlight 3.

In the case where the image signal D1 supplied to the partitioning-drive processing section 42 represents a still image in which a small bright object is present in a dark (gray level) background, the partitioning-emission operation is performed as follows.

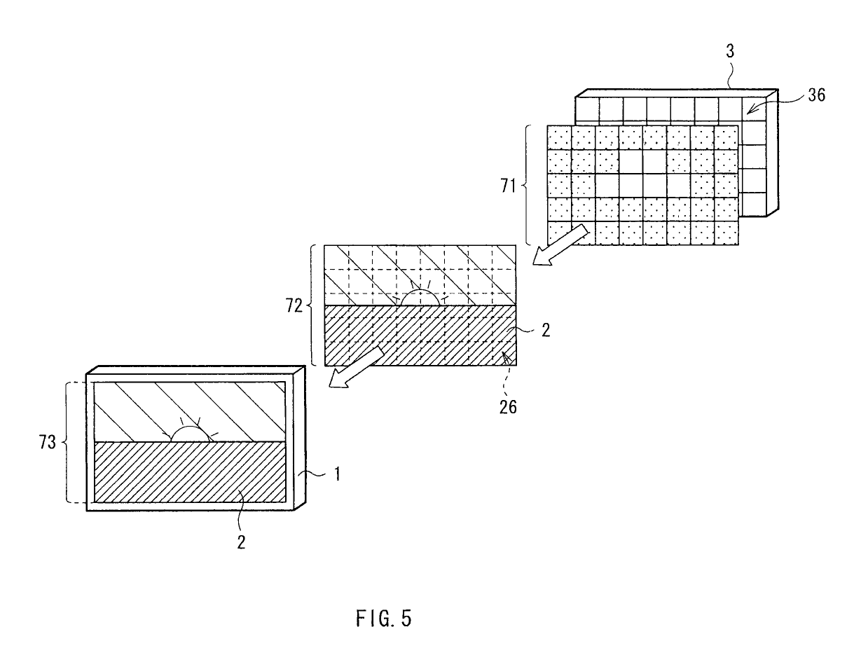

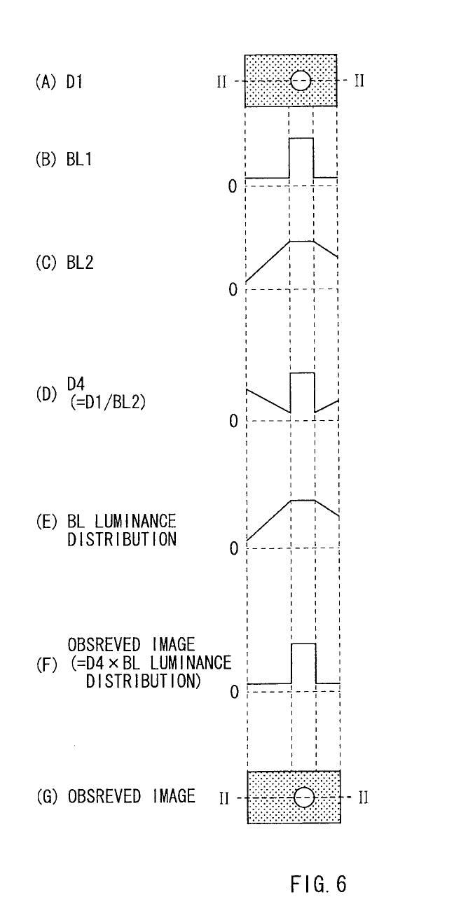

FIG. 6 is a timing chart schematically illustrating the partitioning-emission operation in the liquid crystal display 1 in this case. In FIG. 6, part (A) represents the image signal D1, part (B) represents the emission-pattern signal BL1, part (C) represents the emission-pattern signal BL2, and part (D) represents the partitioning-drive image signal D4 (=D1/BL2). Moreover, part (E) represents the actual luminance distribution (BL luminance distribution) of the backlight 3, and parts (F) and (G) represent an actually observed image (=D4*BL luminance distribution). In parts (B) to (F) of FIG. 6, the horizontal axis indicates a pixel position in the horizontal direction along a II-II line in parts (A) and (G). In parts (A) and (G), the vertical axis indicates a pixel position in the vertical direction of the screen, and in parts (B) to (F), the vertical axis indicates the level axis. It is apparent from FIG. 6 that the content (image) of the input image signal D1 is coincident with the observed image during the image display using the partitioning-emission operation.

2. Operation for Generating Emission-Pattern Signal

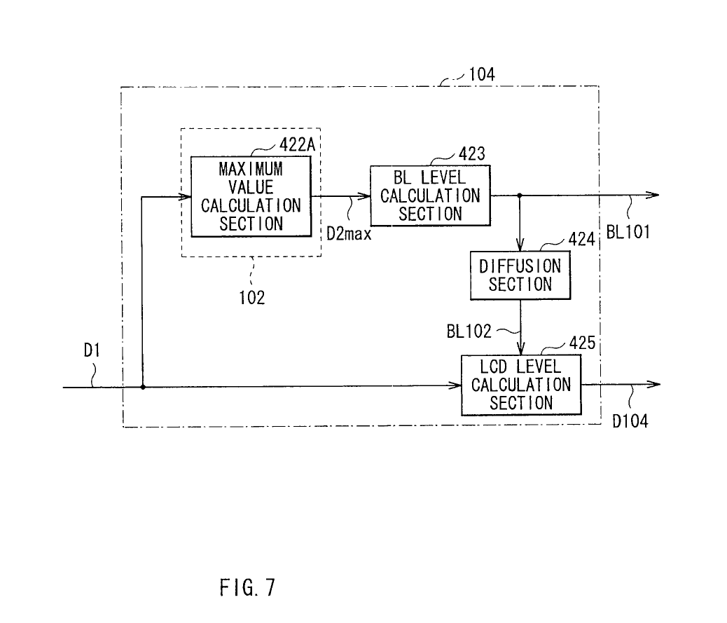

Referring to FIGS. 7 to 10C, the operation for generating the emission-pattern signal BL1 will be described in detail while comparing with a comparative example. This operation is a feature of the embodiment of the invention and is performed by the partitioning-drive processing section 42.

### 2-1. Comparative Example

FIG. 7 illustrates a block configuration of a partitioning-drive processing section (a partitioning-drive processing section 104) of a liquid crystal display according to a comparative example. The partitioning-drive processing section 104 in the comparative example is provided with a resolution reduction processing section 102 having only a maximum value calculation section 422A instead of the resolution reduction processing section 422 in the partitioning-drive processing section 42 of the embodiment illustrated in FIG. 4.

In the partitioning-drive processing section 104, the resolution reduction processing section 102 performs the resolution reduction processing on the image signal D1 to generate the block maximum pixel value D2max that is a maximum pixel value in each of the emission sub-regions 36. Then, the BL level calculation section 423 generates, based on the block maximum pixel value D2max, an emission-pattern signal BL101 representing an emission pattern in each of the emission sub-regions 36. The diffusion section 424 performs the diffusion processing on the emission-pattern signal BL101 output from the BL level calculation section 423 to output the diffused emission-pattern signal BL102 to the LCD level calculation section 425. Subsequently, the LCD level calculation section 425 generates a partitioning-drive image signal D104 based on the image signal D1 and the diffused emission-pattern signal BL102. Specifically, the LCD level calculation section 425 generates the image signal 104 with use of the following equation (3) as in the embodiment.

D104=(D1/BL102) (3)

In this way, the partitioning-drive processing section 104 in the comparative example generates the emission-pattern signal BL102 based on the maximum pixel value (the block maximum pixel value D2max) of the image signal D1 in each of the emission sub-regions 36. In other words, the emission luminance of each of the emission sub-regions 36 is determined depending on the magnitude of the block maximum pixel value D2max.

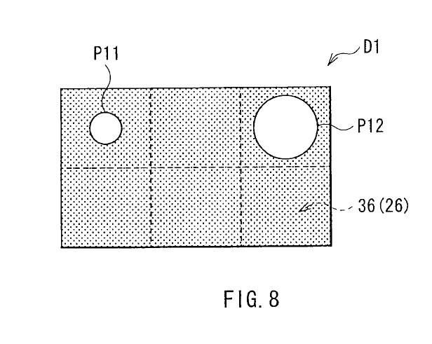

In the technique of the comparative example, there is difficulty in reducing power consumption because the emission luminance of the emission sub-region 36 is set higher than it needs depending on the content of the image signal D1 (pattern of the input image). Specifically, for example, in the case where a still image in which small bright objects P11 and P12 are present in a dark (gray level) background is displayed as the image signal D1 illustrated in FIG. 8, the display is performed as follows. Here, the brightness (luminance levels) of the objects P11 and P12 are equal to each other, whereas the area of the object P12 is larger than that of the object P11. Incidentally, in the following description, the case where the number of the provided emission sub-regions 36 (irradiation sub-regions 26) is 2 vertical*3 horizontal=6 will be described for the sake of convenience.

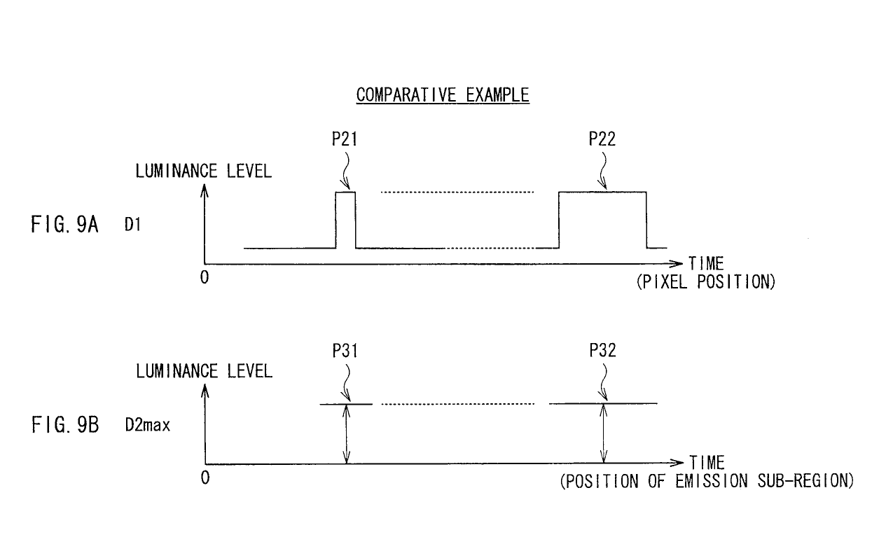

In this case, for example, as illustrated by reference numerals P21 (corresponding to the object P11) and P22 (corresponding to the object P12) in FIG. 9A, the luminance levels of the objects P11 and P12 are equal to each other. Therefore, for example, as illustrated by reference numerals P31 (corresponding to the object P11) and P32 (corresponding to the object P21) in FIG. 9B, the luminance level of the block maximum pixel value D2max in the emission sub-region 36 with the object P11 is also equal to the luminance level of the block maximum pixel value D2max in the emission sub-region 36 with the object P12. Accordingly, in the technique of the comparative example described above, regardless of the size of each area of the objects P11 and P12 (regardless of the magnitude of the average pixel value in each of the emission sub-regions 36), the emission luminance of the emission sub-region 36 with the object P11 and the emission luminance of the emission sub-region 36 with the object P12 are equal to each other. In other words, in an extreme case, even if the object P11 is a small object of one pixel, the emission luminance of the emission sub-region 36 is determined based on the block maximum pixel value D2max corresponding to the luminance of the small object. As a result, in the technique of the comparative example, the case where the emission luminance is set higher than it needs may occur, and the power consumption is increased accordingly. Note that in this case, if the emission luminance of the emission sub-region 36 is decreased lower than it needs in contrast, the power consumption may be reduced but the display quality (display luminance) may be lowered.

### 2-2. Embodiment

On the other hand, in the embodiment, the partitioning-drive processing section 42 calculates, based on the image signal D1, a maximum pixel value (block maximum pixel value D2max) in each of the emission sub-regions 36. In addition, the partitioning-drive processing section 42 calculates, based on the image signal D1, an average pixel value (block average pixel value D2ave) in each of the emission sub-regions 36. Then, the emission-pattern signal BL1 and the partitioning-drive image signal D4 are generated based on both the block maximum pixel value D2max and the block average pixel value D2ave. At this time, specifically, the image signal D3 corresponding to the combined value in the emission sub-region 36 is calculated by combining the block maximum pixel value D2max and the block average pixel value D2ave at a predetermined combining ratio α (refer to the above described equation (1)). Then, the emission pattern signal BL1 and the partitioning-drive image signal D4 are generated based on the image signal D3.

Therefore, in the partitioning-emission operation of the embodiment, for example, as illustrated in FIG. 8, at the time of displaying the image or the like in which the small objects with high luminance is present in the background with low luminance, the emission luminance may be suppressed in the emission sub-region 36, compared with the comparative example described above. In other words, the emission luminance may be suppressed in the emission sub-region 36, compared with the case where the emission-pattern signal and the partitioning-drive image signal are generated by using only the maximum pixel value (the block maximum pixel value D2max) in each of the emission sub-regions 36.

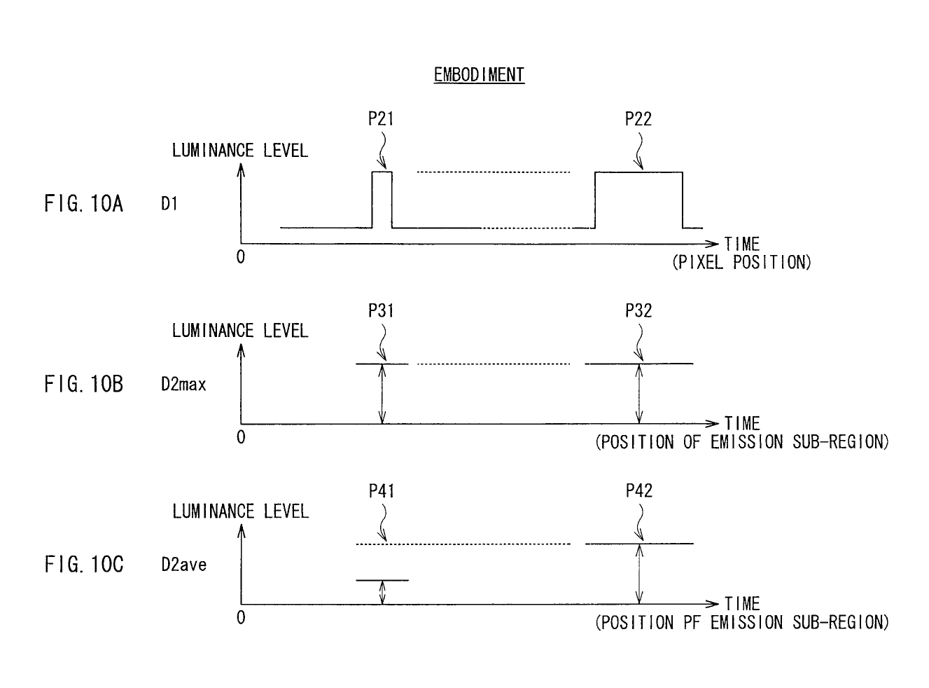

Specifically, in the embodiment, as the image signal D1 illustrates in FIG. 8, for example, the still image in which the small bright objects P11 and P12 are present in the dark (gray level) background is displayed in the following manner. In this case, as illustrated by the reference numerals P21 (corresponding to the object P11) and P22 (corresponding to the object P12) in FIG. 10A, for example, the luminance levels of the objects P11 and P12 are equal to each other. Therefore, similar to the comparative example, as illustrated by reference numerals P31 (corresponding to the object P11) and P32 (corresponding to the object P12) in FIG. 10B, the luminance level of the block maximum pixel value D2max in the emission sub-region 36 with the object P11 is also equal to the luminance level of the block maximum pixel value D2max in the emission sub-region 36 with the object P12. On the other hand, since the area of the object P12 is larger than that of the object P11, for example, as illustrated by reference numerals P41 (corresponding to the object P11) and P42 (corresponding to the object P12) in FIG. 10C, the block average pixel value D2ave in the emission sub-region with the object P12 has a higher luminance level than that of the emission sub-region 36 with the object P11.

Accordingly, in the emission-pattern signal BL1 generated based on the block maximum pixel value D2max and the block average pixel value D2ave thus generated, as long as the combining ratio α is not zero, that is, as long as the value of the block average pixel value D2ave is reflected, the emission luminance of the emission sub-region 36 (in this case, particularly, the emission sub-region 36 with the object P11) is suppressed, compared with the case where the emission-pattern signal and the partitioning-drive image signal are generated with use of only the maximum pixel value (the block maximum pixel value D2max) in each of the emission sub-regions 36.

In addition, with the technique of the embodiment, feeling of discomfort associated with the display quality is almost eliminated. In other words, in the above described example, although the brightness (luminance levels) of the objects P11 and P12 are equal to each other, even if the emission luminance in the emission sub-region 36 with the object P11 is lower than that in the emission sub-region 36 with the object P12, the disadvantage in vision hardly occurs in the emission sub-region 36 with the object P11. This means that discomfort is not felt by human eyes as long as the luminance level of the large area portion (in this case, the background portion with gray level) is reproduced (ensured), even if the luminance level of the small area portion (in this case, the portion of the object P11) is not a correct value.

In the embodiment as described above, the partitioning-drive processing section 42 calculates, based on the image signal D1, the maximum pixel value (the block maximum pixel value D2max) in each of the emission sub-regions 36 and the average pixel value (the block average pixel value D2ave) in each of the emission sub-regions 36. In addition, the partitioning-drive processing section 42 generates the emission-pattern signal BL1 and the partitioning-drive image signal D4 based on both the block maximum pixel value D2max and the block average pixel value D2ave. Therefore, while feeling of discomfort associated with the display quality is almost eliminated, the emission luminance may be suppressed in the emission sub-region 36. Accordingly, when the image display is performed with use of the light source section which performs partitioning-emission operation, the display quality is not lowered (almost maintained), and the power consumption is reduced. In addition, by performing the partitioning-emission operation, it is possible to reduce the power consumption and to improve the black luminance, similarly to the case where the partitioning-emission operation in related art is performed.

Modification

Subsequently, modifications (modifications 1 and 2) of the embodiment will be described. Note that like numerals are used for indicating like components in the embodiment, and the description thereof will be appropriately omitted.

Modification 1

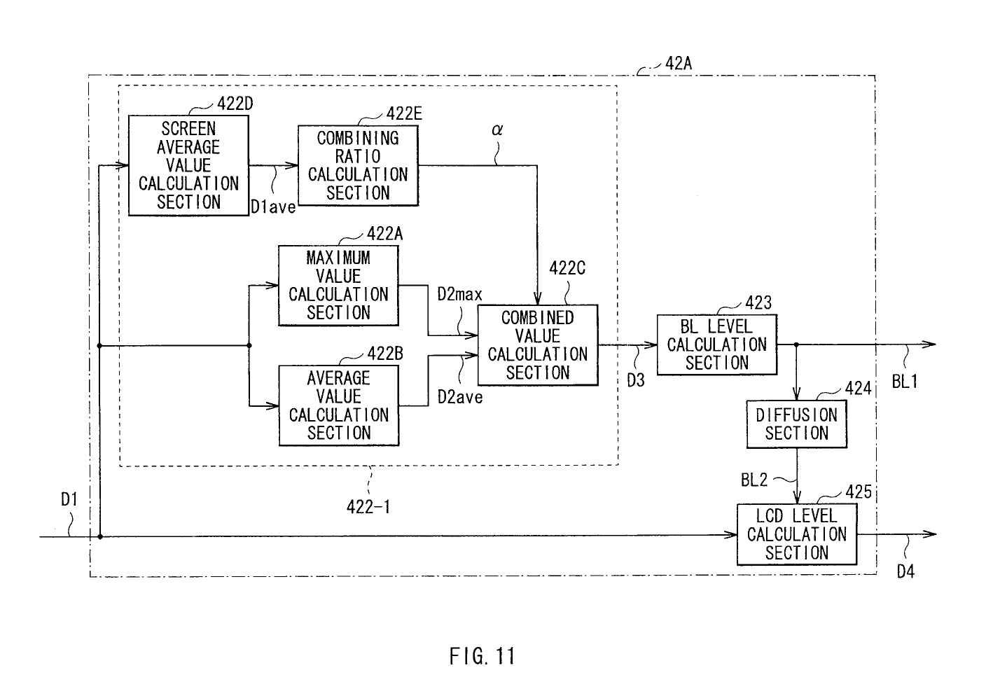

FIG. 11 illustrates a block configuration of a partitioning-drive processing section (a partitioning-drive processing section 42A) in a liquid crystal display according to a modification 1. The partitioning-drive processing section 42A in the modification 1 is provided with a resolution reduction processing section 422-1 which will be described below, instead of the resolution reduction processing section 422 in the partitioning-drive processing section 42 of the embodiment illustrated in FIG. 4.

The resolution reduction processing section 422-1 includes an average pixel value calculation section 422D and a combining ratio calculation section 422E in addition to a maximum pixel value calculation section 422A, an average value calculation section 422B and a combined value calculation section 422C which are similar to those in the resolution reduction processing section 422. Therefore, as will be described later, in the resolution reduction processing section 422-1, the combining ratio α is not fixed but variable at the time of combining a combined value (image signal D3) in the combined value calculation section 422C. Specifically, in this case, the combining ratio α is dynamically changed based on the image signal D1.

The average pixel value calculation section 422D calculates, based on the image signal D1, a screen average pixel value D1ave (a second average pixel value) that is an average pixel value for the entire screen (all pixels 20) of the liquid crystal display panel 2. Incidentally, in this case, although the average pixel value for the entire screen is used, it is enough that the pixel region is larger than the emission sub-region 36 as a target, for example, the emission sub-region 36 as a target, or a pixel region in the vicinity thereof.

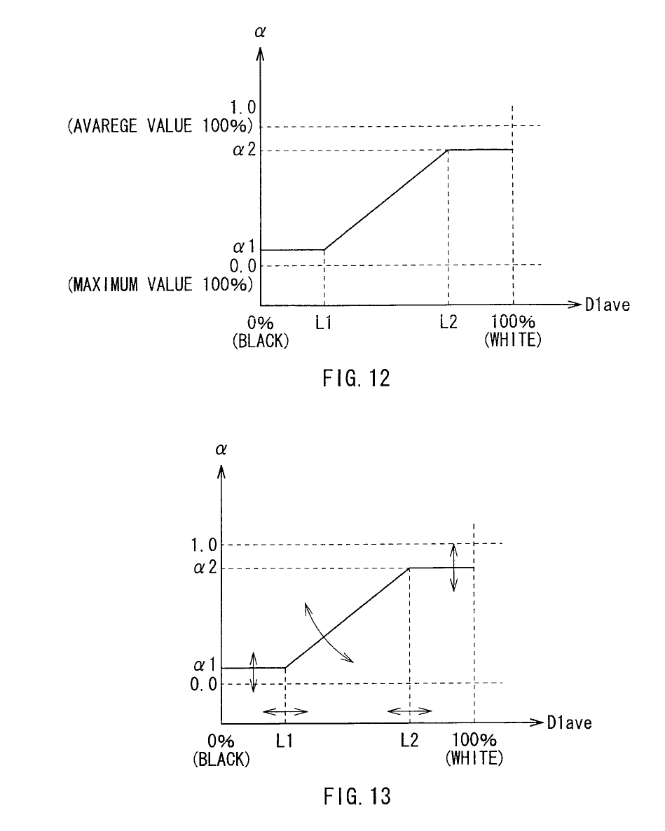

The combining ratio calculation section 422E calculates (determines) a combining ratio α based on the screen average pixel value D1ave output from the pixel average value calculation section 422D. To be specific, for example, as illustrated in FIG. 12, the combining ratio calculation section 422E determines the combining ratio α with use of a table or the like which indicates a correspondence relationship between the screen average pixel value D1ave and the combining ratio α. In other words, the combining ratio α is set so that the value of the combining ratio α is decreased (the proportion of the block maximum pixel value D2max is increased) with the decrease of the value of the screen average pixel value D1ave. In contrast, the combining ratio α is set so that the value of the combining ratio α is decreased (the proportion of the block average pixel value D2ave is increased) with the increase of the value of the screen average pixel value D1ave. Specifically, in the example illustrated in FIG. 12, when the screen average pixel value D1ave is equal to or larger than 0% (corresponding to a black level) and equal to or smaller than the luminance level L1, the combining ratio α has a constant value of α1 (>0). When the screen average pixel value D1ave is equal to or larger than the luminance level L1 and equal to or smaller than the luminance level L2, the combining ratio α increases from α1 to α2 (α1<α2<1) linearly. Further, when the screen average pixel value D1ave is equal to or larger than the luminance level L2 and equal to or smaller than 100% (corresponding to a white level), the combining ratio α has a constant value of α2. However, the correspondence relationship between the screen average pixel value D1ave and the combining ratio α is not limited to the relationship illustrated in FIG. 12, and the relationship indicating other changes may be used.

Moreover, in the characteristic line indicating the correspondence relationship between the screen average pixel value D1ave and the combining ratio α as illustrated in FIG. 12, the magnitude of the set value of the combining ratio α (minimum value α1 and maximum value α2), the gradient of the characteristic line, the position of the bend point or the like may be variable arbitrarily according to the specification of products or settings by a user, for example, as illustrated by arrows in FIG. 13.

In this way, in the modification 1, the value of the combining ratio α at the time of generating the image signal D3 is variable, more specifically, the combining ratio α is dynamically changed based on the image signal D1. Therefore, according to the content of the input image (image pattern), the partitioning-emission operation is achievable more appropriately from the viewpoint of the low power consumption and the high image quality.

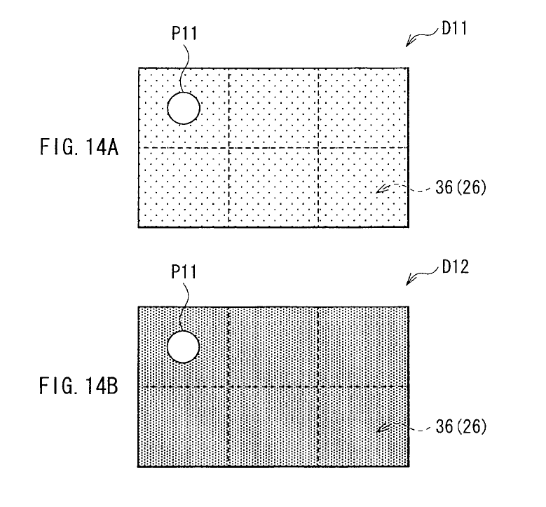

Specifically, for example, the following is found from the comparison between a case of displaying the image signal D11 illustrated in FIG. 14A and a case of displaying the image signal D12 illustrated in FIG. 14B. In the technique of the modification 1, in the case where the level of the background is close to the black level as the image signal D12 illustrated in FIG. 14B, the value of the combining ratio α is set smaller than that in the case where the level of the background is a halftone (gray level) as the image signal D11 illustrated in FIG. 14A. In other words, in the case where the value of the screen average pixel value D1ave is relatively small, the proportion of the block maximum pixel value D2max is set larger, and the emission luminance in the emission sub-region 36 is set higher. This is because when the level of the background is closer to the black level (with decrease of the screen average pixel value D1ave), a difference between the block maximum pixel value D2max and the screen maximum pixel value D1ave becomes larger, and therefore the technique of the modification is preferable from the viewpoint of the display quality. In other words, as the difference described above is increased, visual impression of glitter (shine) corresponding to the block maximum pixel value D2max (peak level) becomes stronger. Therefore, the image quality may be more improved with use of the technique in the modification.

Modification 2

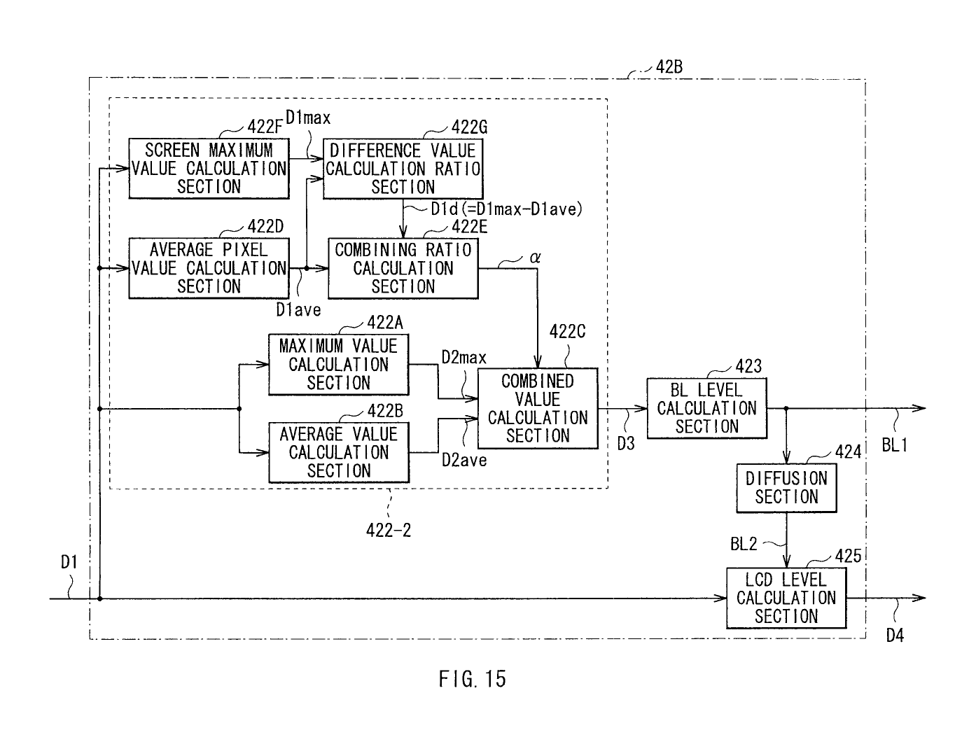

FIG. 15 illustrates a block diagram of a partitioning-drive processing section (a partitioning-drive processing section 42B) of a liquid crystal display according to a modification 2. The partitioning-drive processing section 42B in the modification 2 is provided with a resolution reduction processing section 422-2 which will be described below, instead of the resolution reduction processing section 422-1 in the partitioning-drive processing section 42A in the modification 1 illustrated in FIG. 11.

The resolution reduction processing section 422-2 includes a screen maximum value calculation section 422F and a difference value calculation section 422G in addition to a maximum value calculation section 422A, an average value calculation section 422B, a combined value calculation section 422C, an average pixel value calculation section 422D and a combining ratio calculation section 422E which are similar to those in the resolution reduction processing section 422-1.

The screen maximum value calculation section 422F calculates, based on the image signal D1, a screen maximum pixel value D1max (a second maximum pixel value) that is a maximum pixel value for the entire screen (all pixels 20) in the liquid crystal display panel 2. Although the maximum pixel value for the entire screen is used here, it is enough that the pixel region is larger than the emission subsection 36 as a target, for example, the emission sub-region 36 as a target or a pixel region in the vicinity thereof.

The difference value calculation section 422G calculates a difference value D1d (=D1max−D1ave) between the screen maximum pixel value D1max and the screen average pixel value D1ave. The screen maximum pixel value D1max is output from the screen maximum value calculation section 422F, and the screen average pixel value D1ave is output from the screen average value calculation section 422D.

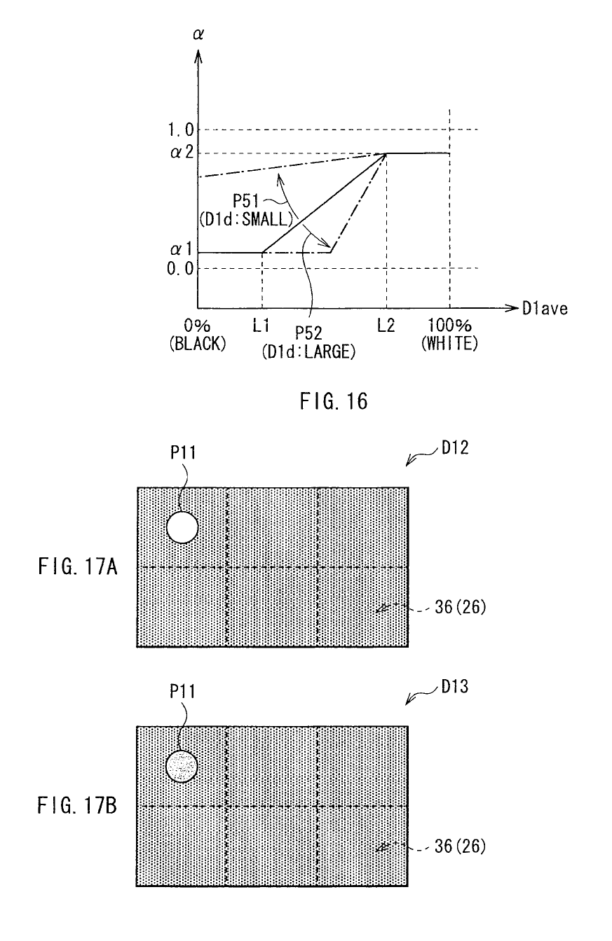

The combining ratio calculation section 422E in the modification 2 calculates (determines) a combining ratio α with use of the difference value D1d output from the difference value calculation section 422G, together with the screen average pixel value D1ave described in the modification 1. To be specific, as illustrated by an arrow P51 in FIG. 16, the combining ratio α is set so that the value of the combining ratio α is increased (the proportion of the block average pixel value D2ave is increased) with decrease of the value of the difference value D1d. In contrast, for example, as illustrated by an arrow P52 in FIG. 16, the combining ratio α is set so that the value of the combining ratio α is decreased (the proportion of the block maximum pixel value D2max is increased) with increase of the value of the difference value D1d.

More specifically, depending on the magnitude of the difference value D1d, the characteristic line representing a correspondence relationship between the screen average pixel value D1ave and the combining ratio α is changed as the following condition (A) or (B).

(A) When the difference value D1d is small, the value of the combining ratio α is set large (minimum value α1 and maximum value α2), the gradient of the characteristic line is set gentle, and the position of the bend portion is set small (on the black level side).
(B) When the difference value D1d is large, the value of the combining ratio α is set small (minimum value α1 and maximum value α2), the gradient of the characteristic line is set steep, and the position of the bent portion is set large (on the white level side).

In this way, in the modification 2, the combining ratio α is determined by using the difference value D1d between the screen maximum pixel value D1max and the screen average pixel value D1ave, in addition to the screen average pixel value D1ave. Therefore, in addition to the effects of the modification 1, the power consumption may be reduced.

Specifically, for example, the following is found from the comparison between a case of displaying the image signal D12 illustrated in FIG. 17A and a case of displaying the image signal D13 illustrated in FIG. 17B. In the technique of the modification 2, in the case where the luminance level of the small object P11 is small (close to the black level) as the image signal D13 illustrated in FIG. 17B, the value of the combining ratio α is set larger than that of the case where the luminance level of the object P11 is large (close to the white level) as the image signal D12 illustrated in FIG. 17A. In other words, in the case where the difference value D1d between the screen maximum pixel value D1max and the screen average pixel value D1ave is relatively small, the proportion of the block average pixel value D2ave is set larger, and the emission luminance in the emission sub-region 36 is set lower. This is because the glittering (shining) impression of white corresponding to the block maximum pixel value D2max (peak level) is remarkably impressed when the block maximum pixel value D2max is large (the difference value D1d is large), and when the block maximum pixel value D2max is small (the difference value Did is small), the brightness of white is less impressed. Consequently, in the latter case, as in the modification 2, the proportion of the block average pixel value D2ave is set larger and the emission luminance of the emission sub-region 36 is set lower, so that the power consumption is further reduced with maintaining the glittering (shining) impression of white.

In the modification 2, although described is the case where the combining ratio α is dynamically changed based on the image signal D1, the combining ratio α may be changed depending on, for example, a display mode (for example, an image quality mode of the TV apparatus) set by a user or the like. For example, at the time of the display mode for reproducing the luminance faithfully (the display quality priority mode), the combining ratio α is set to be small (so that the proportion of the block maximum pixel value D2max becomes large). Therefore, in the display mode for reproducing the luminance faithfully (in the display quality priority mode), it is necessary to change the characteristic line which represents the correspondence relationship between the screen average pixel value D1ave and the combining ratio α as the condition (B). On the other hand, for example, in the display mode for focusing on reduction of the power consumption (low power consumption display mode), the combining ratio α is set to be large (so that the proportion of the block average pixel value D2ave becomes large). Accordingly, in the display mode for focusing on the reduction of the power consumption (low power consumption display mode), it is necessary to change the characteristic line which represents the correspondence relationship between the screen average pixel value D1ave and the combining ratio α as the condition (A). In addition, the following settings lead to a modulated operation between the two display modes like, for example, when the screen average pixel value D1ave is large, the low power consumption display mode is selected, and when the screen average pixel value D1ave is small, the display quality priority mode is selected. The value of the combining ratio α is set small (minimum value α1), the value of the combining ratio α is set large (maximum value α2), and the gradient of the characteristic line is set steep.

### OTHER MODIFICATIONS

Although the present invention has been described with the embodiment and the modifications, the present invention is not limited to the embodiment and the like, and various modifications may be made.

For example, in the embodiment and the like, the case where the backlight is configured to include a red LED, a green LED, and a blue LED as a light source has been described. However, in addition to these LEDs (or instead of these LEDs), a light source emitting other light of color may be included. For example, when the backlight is configured to emit light of four or more colors, the color reproducing range may be widened and thus a wide variety of colors may be represented.

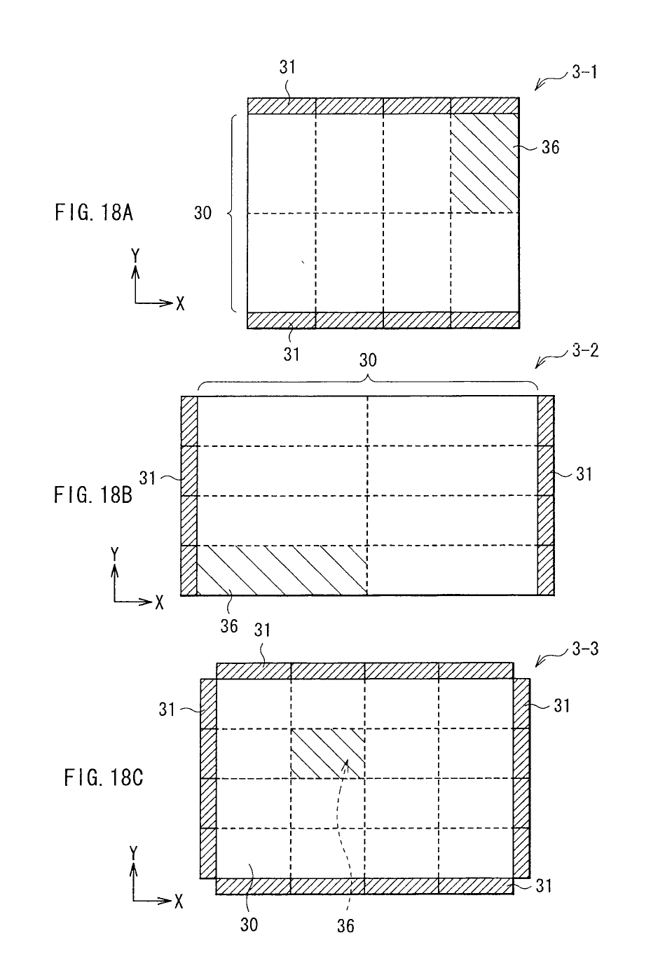

In addition, in the embodiment and the like, although exemplified is the case where the backlight 3 is a so-called direct-type backlight (light source section), the present invention is applicable to an edge-type backlight such as the backlights 3-1 to 3-3 illustrated in FIGS. 18A to 18C. Specifically, the backlights 3-1 to 3-3 each include a rectangular light guide plate 30 forming a light emission surface and a plurality of light sources 31 arranged on sides of the light guide plate 30 (side of the light emission surface). More specifically, in the backlight 3-1 illustrated in FIG. 18A, the plurality (in this case, four) of light sources 31 are arranged on each of a pair of opposed sides (sides in the vertical direction) of the rectangular light guide plate 30. In addition, in the backlight 3-2 illustrated in FIG. 18B, the plurality (in this case, four) of light sources 31 are arranged on each of a pair of opposed sides (sides in the horizontal direction) of the rectangular light guide plate 30. Moreover, in the backlight 3-3 illustrated in FIG. 18C, the plurality (in this case, four) of light sources 31 are arranged on each of two pairs of opposed sides (sides in the horizontal and vertical direction) of the rectangular light guide plate 30. With such a configuration, in the backlights 3-1 to 3-3, the plurality of emission sub-regions 36 which are controlled separately from one another are formed on the light emission surface of the light guide plate 30.

In addition, a series of process described in the embodiment or the like may performed by hardware or by software. When the series of process is performed by software, a program configuring the software is installed into a general-purpose computer or the like. Such a program may be recorded in advance in a recording medium embedded in the computer.

The present application contains subject matter related to that disclosed in Japanese Priority Patent Application JP 2010-114655 filed in the Japan Patent Office on May 18, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A liquid crystal display comprising:
a light source section including a plurality of emission subsections which are controlled separately from one another;
a liquid crystal display panel performing image display through modulating, based on an input image signal, light coming from each of the emission subsections in the light source section; and
a display control section having a partitioning-drive processing section which generates an emission-pattern signal and a partitioning-drive image signal based on the input image signal, the emission-pattern signal representing an emission-pattern formed of lighting emission subsections in the light source section, the display control section performing light-emission drive on each of the emission subsections in the light source section with use of the emission-pattern signal, and performing display-drive on the liquid crystal display panel with use of the partitioning-drive image signal,
wherein the partitioning-drive processing section performs,
calculation of a first maximum pixel value and a first average pixel value based on the input image signal, the first maximum pixel value representing a maximum pixel value in each of pixel regions which correspond to the respective emission subsections, and the first average pixel value representing an average pixel value in each of the pixel regions, and
generation of the emission-pattern signal and the partitioning-drive image signal based on both the first maximum pixel value and the first average pixel value.

2. The liquid crystal display according to claim 1, wherein the partitioning-drive processing section combines, at a predetermined combining ratio, the first maximum pixel value and the first average pixel value into a combined value for each of the emission subsections, to generate the emission-pattern signal and the partitioning-drive image signal based on the combined value.

3. The liquid crystal display according to claim 2, wherein the combining ratio is variable.

4. The liquid crystal display according to claim 3, wherein the partitioning-drive processing section allow the combining ratio to dynamically change based on the input image signal.

5. The liquid crystal display according to claim 4, wherein the partitioning-drive processing section calculates a second average pixel value based on the input image signal, and determines the combining ratio based on the second average pixel value, the second average pixel value representing an average pixel value in a pixel region larger than the emission subsection.

6. The liquid crystal display according to claim 5, wherein the combining ratio is determined to allow a proportion of the first maximum pixel value in the combined value to be increased with decrease of the second average pixel value, and to allow a proportion of the first average pixel value in the combined value to be increased with increase of the second average pixel value.

7. The liquid crystal display according to claim 5, wherein the partitioning-drive processing section further performs,
calculation of a second maximum pixel value based on the input image signal, the second maximum pixel value representing a maximum pixel value in the larger pixel region, and
determination of the combining ratio with use of a difference value between the second maximum pixel value and the second average pixel value as well as with use of the second average pixel value.

8. The liquid crystal display according to claim 7, wherein the combining ratio is determined to allow a proportion of the first average pixel value in the combined value to be increased with decrease of the difference value, and to allow a proportion of the first maximum pixel value in the combined value to be increased with increase of the second average pixel value.

9. The liquid crystal display according to claim 3, wherein the partitioning-drive processing section allow the combining ratio to change depending on a given display mode.

10. The liquid crystal display according to claim 9, wherein the partitioning-drive processing section allow the proportion of the first maximum pixel value in the combined value to change to be increased when the display mode is image-quality priority mode.

11. The liquid crystal display according to claim 9, wherein the partitioning-drive processing section allow the proportion of the first average pixel value in the combined value to change to be increased when the display mode is image-quality priority mode.

12. The liquid crystal display according to claim 1, wherein the light source section is of a direct-lighting type or edge-lighting type.
